(19) United States
(12) Patent Application Publication
(10) Pub. No.: US 2013/0314791 A1
(43) Pub. Date: Nov. 28, 2013

(54) Heated Mirror

(71) Applicants: Andreas Ullmann, Zirndorf (DE); Walter Fix, Furth (DE)

(72) Inventors: Andreas Ullmann, Zirndorf (DE); Walter Fix, Furth (DE)

(73) Assignee: PolylC GmbH & Co. KG, Furth (DE)

(21) Appl. No.: 13/976,318

(22) PCT Filed: Dec. 28, 2011
(86) PCT No.: PCT/EP2011/074184

§ 371 Date: Jul. 30, 2013

(30) Foreign Application Priority Data
Dec. 30, 2010 (DE) 10 2010 056 493.1

(51) Int. Cl. H05B 3/84

(52) U.S. Cl. CPC H05B 3/84
USPC 359/512; 427/162; 427/556

(57) ABSTRACT

The mirror includes a flexible support layer with at least one metallic layer and electrical contacts on the support layer, wherein the metallic layer forms the mirror and contains interruptions smaller than 100 μm, through which metallic layer an electric current applied to the mirror to heat the mirror is evenly distributed along the metallic layer, which has a thickness of about 700 nm or less. The interruptions are so constructed as to avoid hot spots in the metallic layer when heated. The mirror and its heating functions are produced on one production line.

The invention relates to a heated mirror, as used, for example, in automotive engineering.

An electric functional layer which is transparent is known from DE 10 2009 014 757.8, wherein [the conductivity by means of] conductive, non-transparent tracks are arranged parallel to the surface of a transparent carrier, forming a pattern, such that in the pattern a conductor path spacing is realized which ensures conductivity of the film with at the same time transparency.

A multilayer body with adjustable electrical conductivity is known from DE 10 2005 049 891.4, wherein first regions having metallization and second regions without metallization become detached, the end effect of which is that a metallic-looking layer, with possibly very low conductivity, can be produced.

A method for producing plastic moulded parts having an integrated conductor path, which plastic moulded parts can be further processed, for example, into electrically heated mirrors, is known from WO 2010/133530. In the method a plastic moulded part having an integrated conductor path is flooded with a liquid, electrically insulating coating material, so that all the irregularities on the thus-coated surface of the substrate are evened out.

A heated mirror on a plastic or glass substrate is known from GB 2303465, in which a metallic layer is applied by electroplating in a thickness of, for example, 10 μm, into which cavities are then carved. Two sides of the metallic layer are contacted via electrical contacts, such that the metallic layer can be heated. A transparent plastic film is applied to this layer to protect against mechanical damage.

A disadvantage of the known mirror heating systems is that, in the case of metallic layers which are several pm thick, it is not possible to use a flexible substrate which can be back injection moulded, for example, in a second work step to produce the finished mirror. In addition, isolated hot spots, i.e. temperature peaks, caused by uneven electric current distribution within the heating system are to be expected, if no measures are taken to counter this, because the electric current always takes the path of least resistance.

The object of the present invention is therefore to reduce the complexity of producing mirror heating systems without generating isolated temperature peaks (so-called hot spots) on the mirror.

This object is achieved by the subject-matter of the claims in conjunction with the description and the figures.

The general finding of the invention is that it is possible to combine the production of the heating function and the mirror function, so that the metallic layer can be used for heating without generating hot spots. Previously, the metallic layer could not be used for heating, because the electric current always takes the path of least resistance and, as a result, only very uneven heating was possible. This resulted in hot spots on the mirror, which cannot be tolerated.

The subject-matter of the invention is thus a heated mirror comprising a support layer with at least one metallic layer and electrical contacts, wherein the metallic layer contains high-resolution interruptions which are scarcely perceptible to the human eye, through which electric current can be evenly distributed along the metallic layer and thus the metallic layer can be used for heating. In addition, the subject-matter of the invention is a method for producing a heated mirror, wherein a metallic layer is applied in a structured manner to a support layer, such that interruptions are formed which make it possible to distribute the heat output of the electric current conducted through the metallic layer evenly.

According to an advantageous embodiment of the invention the metallic layer is formed by a thin metallization on the substrate. Irrespective of the production process of the metallic layer, layer thicknesses of less than/equal to 700 nm, preferably less than/equal to 500 nm and particularly preferably less than/equal to 300 nm are realized for this layer.

According to an advantageous embodiment of the invention, the thin metallic layer is produced by printing.

According to an advantageous embodiment of the invention the result of the interruptions is that adjoining areas of the metallic layer are electrically isolated from one another.

According to an advantageous embodiment, the interruptions are in a meandering pattern. This results in a particularly even distribution of the heating function, so that optimum heating becomes possible.

According to an advantageous embodiment, the interruptions are in the form of simple lines or bands which run through the metallic layer. It is particularly advantageous if the interruptions divide the metallic layer such that the metallization or the metallic layer covers the entire surface of the mirror like a thick, continuous band by means of appropriate folding, wherein the individual folds of the band are electrically isolated from one another because of the interruptions.

According to an advantageous embodiment, the interruptions are cavities in the metallic layer.

According to an advantageous embodiment, the interruptions are filled.

For example, an insulating material is located in the interruptions. This is particularly advantageous since the depth and width of the interruption can then be minimized, as the insulating material ensures the electrical isolation of the adjoining areas of the metallic layer.

According to an advantageous embodiment of the invention, the width of the interruptions is less than 100 μm, preferably less than 70 μm, particularly preferably less than 50 μm and quite particularly preferably less than 10 μm.

According to an advantageous embodiment, the interruptions on the metal layer are arranged in a regular, repeating pattern.

According to an advantageous embodiment, there is a further layer with insulating material on the metallic layer with interruptions. It is preferably an electrically insulating material which, however, conducts heat well.

A further, i.e. a second, metallic layer which again has interruptions can, for example, be applied to the layer with insulating material, if this layer is transparent or at least semi-transparent. These interruptions are then, for example, regular as well and in the form of a moiré pattern, so that a moiré effect occurs, in which the pattern of the upper interruptions fits in with the moiré pattern of a lower metallized layer with interruptions.

A moiré pattern here is a pattern formed from repeating structures which, on superimposition with or looking through a further pattern formed by repeating structures, displays a new pattern which is concealed in the moiré pattern.

The moiré effect with an upper, metallic and structured layer, i.e. a second metallic layer provided with interruptions, which is isolated from the lower metallic layer by a layer of insulation, can also be used in order that the interruptions become invisible to the human eye.

The film with metallizations forms the mirror which can then be back injection moulded without further work steps, so that, for example, the production of the finished exterior mirror in the automotive sector does not require any additional process steps other than back injection moulding.

For better durability, the mirror can be provided with one or more additional protective layers. For example, a protective layer such as an anti-corrosion layer or a weathering protective layer or a scratch protection layer can be applied to the mirror. Of course, other types of layers such as filter layers or polarization layers can be applied to the mirror.

For example, these protective layers are applied to the side of the support layer opposite the metallic layer. Of course, the application of an anti-corrosion layer to the metallic layer is also advantageous.

The support layer is preferably a film, in particular a transparent film, in particular one of the common plastic films such as, for example, a PET (polyethylene terephthalate), PP (polypropylene), PEN (polyethylene naphthalate), PVC (polyvinyl chloride), PE (polyester) and/or PC (polycarbonate) film. However, the support layer can also consist of glass or ceramic, i.e. a metal oxide. The support layer can be rigid or flexible, i.e. bendable.

The thickness of the support layer can be freely selected, as can the thickness of the mirror glass today. For example, it is in the range of 1 to 10 millimetres, preferably below 5 mm. A substrate can also be a multi-layer film composite. Advantageously, the film is at least 500 μm, but it can also be only 100 μm thick or even thinner.

The materials of the metallic layer can also be freely selected. For example, the metallization can consist of silver, aluminium, chromium or also a composite of layers of metals such as, for example, silver with a thin chromium layer.

Scratch protection layers and/or anti-corrosion layers can include all kinds of protective layers, particularly preferably mechanically stable and/or hydrophobic, i.e. water-repellent layers. For example, siloxane layers or other cross-linked and/or hardened layers, which can be produced for example by means of condensation reactions on the support layer, can be used here.

The protective layers, as well as all the other layers named here can, in turn, be formed from composites of layers, i.e. laminates having layers of very different characteristics, comprising organic, inorganic, organometallic, metallic or other layers.

All kinds of sensors, transmitters and/or receivers can also be integrated into the protective layer or protective layers, so that, for example, the temperature, humidity or other values can be read by the thus-formed heated mirror with the aid of suitable electronics.

On the other hand, further layers can also be applied to the metallization side of the mirror, on which the interruptions in accordance with the invention are also located. For example, further conductor paths can be provided for selective heating and/or dimming.

An anti-corrosion layer is also preferably applied to the metallized side of the support film, in order that the service life of the metallization is as high as possible.

The invention will be explained in more detail below by means of figures which show exemplary embodiments of the invention:

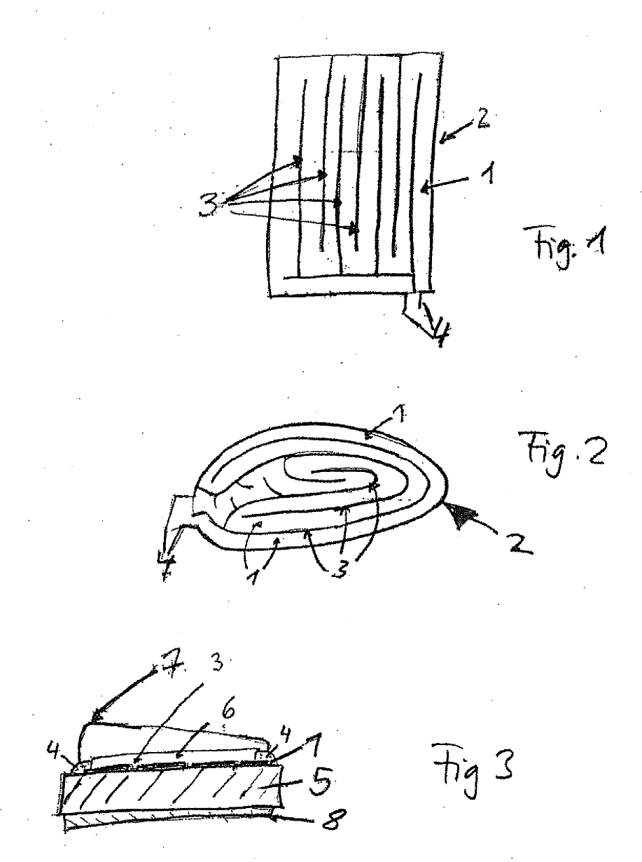

FIG. 1 shows a top view according to one embodiment of the present invention,

FIG. 2 shows a top view of a metallic layer with interruptions according to another embodiment of the invention, and

FIG. 3 shows a cross-section through a mirror according to an embodiment of the present invention.

FIG. 1 shows the metallic layer 1 which forms the mirror 2. Long thin lines 3, which form the interruptions which separate the individual areas of the metallic layer 1 from one another, run through the metallic layer 1. The areas of the metallic layer 1 are connected to the contacts 4.

FIG. 2 shows a similar top view, but the form of the interruptions 3 is different here. Otherwise, again, 2 is the mirror as a whole, here in the form of a car's exterior mirror, 1 indicates the thick metallized areas largely covering the surface of the mirror which are interrupted by the thin lines 3, the interruptions 3. The metallic areas 1 are connected to the contacts 4.

FIG. 3 finally shows the layer structure of an embodiment example. The thick layer 5 constitutes the substrate, i.e. the support layer. The metallic layer 1 with structuring forming the interruptions 3 can be seen on the support layer 5. The interruptions 3 merge into the corrosion layer 6, so that, in the example shown here, the embodiment is realized in which the interruptions 3 are cavities in the metallic layer 1, which are filled, in this case, with the material of the anti-corrosion layer 6. The two contacts are connected by a line feeder 7. The line feeder 7 is advantageously embedded in a contact protection layer.

The invention shows, for the first time, that in the case of a heated mirror it is possible to produce the mirror function and the heating function on one production line. The metallized layer of the mirror is structured such that it can be used for heating with appropriate electrical connections.

1. Heated mirror comprising a support layer (5) with at least one metallic layer (1) and electrical contacts (4), wherein the metallic layer (1) contains high-resolution interruptions (3) which are scarcely perceptible to the human eye, through which electric current can be evenly distributed along the metallic layer (1) and thus the metallic layer (1), the layer thickness of which is less than/equal to 700 nm, can be used for heating.

2. Heated mirror according to claim 1, wherein the support layer (5) is transparent.

3. Heated mirror according to one of claim 1 or 2, wherein the result of the interruptions (3) is that adjoining areas of the metallic layer (1) are electrically isolated from one another.

4. Heated mirror according to one of claims 1 to 3, wherein the interruptions (3) are arranged in a meandering pattern.

5. Heated mirror according to one of the preceding claims, wherein the interruptions (3) have the form of simple lines or bands.

6. Heated mirror according to one of the preceding claims, wherein the interruptions (3) are cavities in the metallic layer.

7. Heated mirror according to claim 6, wherein the cavities are filled.

8. Heated mirror according to one of the preceding claims, wherein the width of the interruptions (3) is less than 100 μm.

9. Heated mirror according to one of the preceding claims, wherein a second layer with insulating material is provided on the first metallic layer (1) with interruptions (3).

10. Heated mirror according to claim 9, wherein the layer with insulating material is transparent.

11. Heated mirror according to one of the preceding claims, wherein the interruptions (3) in the metallic layer (1) are arranged in a regular, repeating pattern.

12. Heated mirror according to claim 10, wherein a second metallic layer with interruptions is also arranged on the layer with insulating material, which is arranged on the first metallic layer (1) with interruptions (3).

13. Heated mirror according to one of the preceding claims 10 to 12, wherein the patterns of the two metallic layers display a moiré effect.

14. Heated mirror according to one of the preceding claims, which is provided with an additional protective layer (6, 8).

15. Heated mirror according to claim 14, wherein a sensor, transmitter and/or receiver is also integrated into the protective layer (6, 8).

16. Heated mirror according to claim 15, wherein on the side of the metallic layer (1) of the mirror (2), on which the interruptions (3) are also located, conductor paths are provided for selective heating and/or for dimming.

17. Heated mirror according to one of the preceding claims, in which an anti-corrosion layer (6) is applied to a metallic layer.

18. Method for producing a heated mirror, wherein a metallic layer (1) is applied in a structured manner to a support layer (5), such that interruptions (3) are formed which ensure an even distribution of the heat output of the electric current conducted through the metallic layer (1).

19. Method according to claim 18, wherein the structured metallic layer (1) is produced by printing.

20. Method according to claim 18, wherein the structured metallic layer (1) is produced in two steps by means of coating and subsequent structuring.

21. Method according to claim 18 or 20, wherein the structuring of the metallic layer (1) is produced by means of a laser.
